(19) United States
(12) Patent Application Publication
(10) Pub. No.: US 2022/0337955 A1
(43) Pub. Date: Oct. 20, 2022

(54) FLAT SPEAKER INCLUDING ASYMMETRICAL MAGNETIC BODIES AND BASE FRAME

(71) Applicant: OCLIER CO., LTD., Seoul (KR)

(72) Inventor: Dong-Man KIM, Seoul (KR)

(21) Appl. No.: 17/760,648

(22) PCT Filed: Sep. 16, 2020
(86) PCT No.: PCT/KR2020/012465

§ 371 Date: Mar. 15, 2022

(30) Foreign Application Priority Data
Sep. 17, 2019 (KR) 10-2019-0114256

(51) Int. Cl. H04R 7/26; H04R 9/02; H04R 7/04

(52) U.S. Cl. CPC H04R 7/26; H04R 9/025; H04R 7/04

(57) ABSTRACT

The flat speaker according to an embodiment of the present invention includes a voice coil plate, a diaphragm for generating sound according to vertical vibration of the voice coil plate, a damper contacting a lower end surface of the voice coil plate, and a yoke having a first yoke having a “-” shape in cross section and a second yoke having an “L” shape in cross section and the first and second yokes are disposed to face to each other to form asymmetry.

### TECHNICAL FIELD

The present invention relates to a flat speaker. More specifically, the present invention relates to a flat speaker having an asymmetrical magnetic body, which improves air flow and improves the efficiency of a magnetic field according to vertical vibration.

### BACKGROUND ART

A speaker includes a voice coil plate and a diaphragm interposed between magnets. The speaker generates sound by vibrating the diaphragm by the movement of the voice coil plate.

The voice coil plate used in the flat speaker is formed by winding or printing pattern in an oval shape on the cross section or both sides of the coil base of a plate-shaped coil base.

When a current flows through the voice coil, the voice coil plate generates a magnetic field which expands and then contracts around the voice coil due to the flowing current at the same frequency as the audio signal. The voice coil is hung on a magnetic field generated by a magnet in a magnetic circuit composed of a yoke and a magnet. Therefore, in response to such a magnetic field, the voice coil plate vibrates up and down while interacting with the magnetic field generated in the voice coil. The diaphragm bonded to the voice coil plate vibrates up and down to push air. Sound is generated by the vibration of the pushed air.

For such flat speakers, there is a trend of increasing the output capacity and developing to minimize the size. However, as the size decreases, the smooth flow of air inevitably deteriorates. As a result, there is a problem in that the performance of the speaker is degraded by interfering with the smooth vertical vibration of the diaphragm.

In addition, magnets disposed on both sides of the voice coil plate are disposed so that different polarities face each other. Therefore, magnets have the property of trying to stick to each other by attraction force.

Therefore, in order to maintain an air gap between magnets with the voice coil plate interposed therebetween, a separate additional bonding operation for fixing the magnet and the yoke is required.

In addition, when a strong signal of a low-band is input, the amplitude of the voice coil plate is proportionally increased. In the meantime, a reverse magnetic field is applied to the track of the voice coil plate. As a result, it is difficult to reproduce delicate sound because the vertical vibration of the voice coil plate is not stable. As a result, there are often very unstable cases in the reproduction of sound.

### PRIOR ART LITERATURE

### (Patent Document 1) Korean Patent Publication No. 10-1154250 (2012 Jun. 1)

### (Patent Document 2) Korean Patent Publication No. 10-1119493 (2012 Feb. 16)

### DISCLOSURE

### Technical Problem

The present invention is derived to solve the above-described problem. The present invention reduces the size of the speaker. The present invention improves the performance of a speaker by improving the flow of air at the lower end of the diaphragm inside the speaker. According to the present invention, production efficiency can be increased by reducing the work process. The present invention reduces the size of a magnet. In the present invention, even when a low-band strong signal is input, the coil track of the voice coil plate is disposed in the center of the yoke of the magnetic circuit. An object of the present invention is to implement a flat speaker capable of improving sound performance accordingly.

### Technical Solution

The flat speaker according to an embodiment of the present invention may include a voice coil plate, a diaphragm which generates sound according to vertical vibration of the voice coil plate, a damper in contact with a lower end surface of the voice coil plate, and magnets disposed in parallel on both sides of the voice coil plate; and a yoke having a first yoke having a “-” shape in cross section and a second yoke having an “L” shape in cross section and the first and second yokes are disposed opposite to each other to form asymmetry.

The second yoke further comprises a base portion in contact with the magnet and a bent portion which is bent in an orthogonal direction of the base portion, wherein the bent portion may be positioned adjacent to a side surface portion of the voice coil plate.

The first yoke may comprise a magnet fixing part protruding to prevent contact between the magnets due to attraction.

The second yoke may comprise a base portion in contact with the magnet and a bent portion which is bent in an orthogonal direction of the base portion, and when the second yoke is positioned on an upper surface of the magnet, the bent portion may be bent upward and when the second yoke is positioned on a lower surface of the magnet the bent portion is bent downward.

The second yoke may comprise a base portion in contact with the magnet and a bent portion which is bent in an orthogonal direction of the base portion, and an upper surface or a lower surface of the first yoke and a front end surface of the bent portion may be placed on a same horizontal extension line.

The first yoke may be disposed on an N-pole surface of the magnet, and the second yoke may be disposed on a S-pole surface of the magnet.

The magnets may be disposed at different vertical positions with respect to the voice coil plate.

The flat speaker according to an embodiment of the present invention may comprise a base frame supporting the diaphragm and the damper, and the base frame further comprises side through holes penetrated through both sides so that the magnet and the yoke can be inserted into an inner space and a yoke guide part fixing both ends of the yoke to limit a minimum value of the spacing distance between the magnets inserted into the inner space.

The base frame may comprise at least one insertion holes formed on each of both side surfaces, and a jig is fixed through the insertion hole to guide a center of the voice coil plate by the jig.

### Advantageous Effects

According to the present invention, it is possible to reduce the production cost and weight by reducing the volume of the magnet.

According to the present invention, a reverse magnetic field is not generated even when a low-band signal is input, and thus stable vertical vibration of the voice coil plate may be implemented.

According to the present invention, the amplitude of the voice coil plate may be sufficiently secured even when a low-band signal is input, so that sound may be stably reproduced.

According to the present invention, the air flow inside the air gap is smooth, so that noise generated between unnecessary air gaps is not generated. According to the present invention, it is possible to stably reproduce sound by smoothly vibrating the diaphragm up and down.

According to the present invention, the movement of the magnet is limited by the magnet fixing part provided in the yoke. According to the present invention, the air gap is permanently maintained, so that the performance of the speaker may be maintained even in long-term use.

According to the present invention, the bonding process of the magnet and the first yoke is omitted, thereby simplifying the work process and improving production efficiency.

According to the present invention, the voice coil plate is accurately fixed to the center of the speaker diaphragm by maintaining an accurate air gap. Accordingly, the performance of the speaker may be improved.

However, the effects of the present invention are not limited to the effects, and may be variously extended within the spirit and scope of the present invention.

### DESCRIPTION OF DRAWINGS

FIG. 1 is a perspective view of a flat speaker according to an embodiment of the present invention.

FIG. 2 is an exploded perspective view of a flat speaker according to an embodiment of the present invention.

FIG. 3 is a plan view (a) of a flat speaker (a diaphragm is not shown), a side view (b) and a cross-sectional view (c) A-A according to an embodiment of the present invention.

FIG. 4 is a perspective view (a), a side view (b), and a cross-sectional view (c) of a base frame according to an embodiment of the present invention.

FIG. 5 is a view illustrating (a) the configuration and arrangement of a magnetic circuit according to an embodiment of the present invention, and (b) is a side view of FIG. 5(a).

FIG. 6 is a perspective view of a yoke according to an embodiment of the present invention.

FIG. 7 is a reference diagram for explaining a difference between a conventional flat speaker (a) and a flat speaker (b) according to an embodiment of the present invention.

### MODE FOR INVENTION

A detailed description of the present invention, which will be described later, is referred to the accompanying drawings illustrating a specific embodiment in which the present invention may be implemented as an example. These embodiments are described in detail so that those skilled in the art may implement the present invention. It should be understood that various embodiments of the present invention are different from each other, but need not be mutually exclusive. For example, the specific shapes, structures, and characteristics described herein may be implemented in other embodiments without departing from the spirit and scope of the present invention in relation to one embodiment. In addition, it should be understood that the location or arrangement of individual components in each disclosed embodiment may be changed without departing from the spirit and scope of the present invention. Therefore, the detailed description to be described below is not limited in meaning, and the scope of the present invention is limited only by the appended claims as well as all scopes equivalent to those claimed in the claims, if appropriate. In the drawings, similar reference numerals refer to the same or similar functions across several aspects.

Detailed descriptions of specific embodiments shown in the accompanying drawings are read in connection with the accompanying drawings, and the drawings are considered to be part of the explanation of the entire invention. The mention of direction or orientation is only for convenience of explanation and has no intention of limiting the scope of the present invention in any way.

Specifically, terms indicating positions such as “down, up, horizontal, vertical, upper, lower, upward, downward, upper portion, and lower portion”, or derivatives thereof (e.g., “horizontally, downwardly, upwardly, etc.) should be understood with reference to both the drawings being described and related descriptions. In particular, since such a relative language is only for convenience of description, it does not require that the apparatus of the present invention be configured or operated in a specific direction.

In addition, a term representing an interconnection relationship between components such as “mounted, attached, connected, coupled, interconnected” may mean a state in which individual components are directly or indirectly mounted, attached, connected, or coupled, unless otherwise stated.

When adding reference numerals to the components of the drawings, it should be noted that the same components have the same reference numerals as much as possible even though they are indicated in different drawings. In addition, in describing the present invention, when it is determined that a detailed description of a related known configuration or function may obscure the gist of the present invention, the detailed description thereof will be omitted.

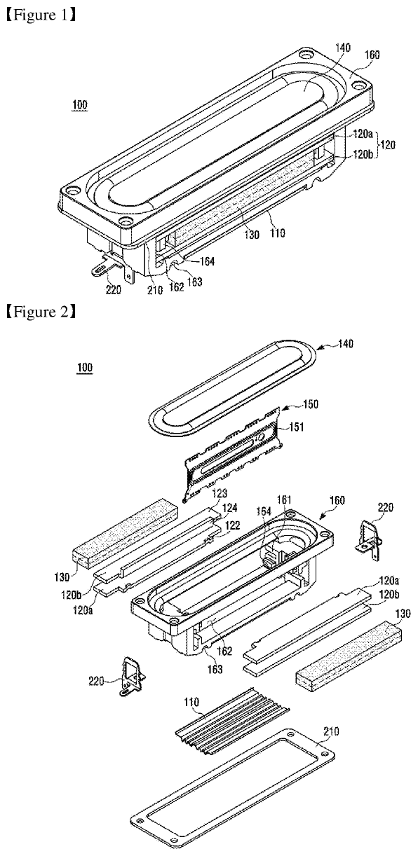

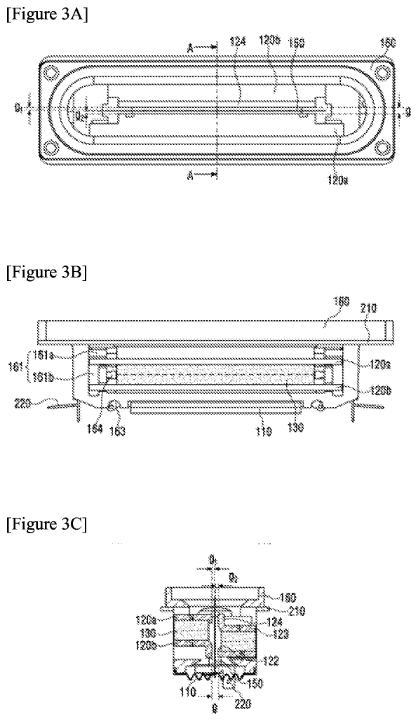

FIG. 1 is a perspective view of a flat speaker 100 according to an embodiment of the present invention. FIG. 2 is an exploded perspective view of a flat speaker 100 according to an embodiment of the present invention. FIG. 3 is a plan view (a), a side view (b), and a cross-sectional view (c) A-A of the flat speaker 100 according to an embodiment of the present invention. FIG. 3 illustrates a diaphragm 140 to facilitate identification of the configuration and coupling state of the speaker.

Referring to FIGS. 1 to 3, a flat speaker 100 according to an embodiment of the present invention may include a voice coil plate 150, a diaphragm 140, a damper 110, magnets 130, a yoke 120, a base frame 160, a lead terminal 210 for fixing the flat speaker 100 to an object and a gasket-shaped fixing member 220.

The voice coil plate 150 may be vertically erected at the center of the flat speaker 100. A voice coil 151 may be formed on one or both surfaces of the voice coil plate 150 by being wound or pattern-printed in an oval shape.

The diaphragm 140 is adhered to an upper end surface of the voice coil plate 150. Therefore, the diaphragm 140 may vibrate according to vertical vibration of the voice coil plate 150 to generate sound.

The diaphragm 140 may include a connection part (also referred to as an edge) connected to the base frame 160. The connection part and the diaphragm 140 may be integrated or separated.

The damper 110 is bonded to a lower end surface of the voice coil plate 150. The damper 110 may serve to assist the vertical vibration of the voice coil plate 150.

The damper 110 may be made of a cloth having wrinkles. The outer periphery of the damper 110 may be adhered and fixed to the base frame 160. The damper 110 may have elasticity such that the voice coil plate 150 returns to its original state after vertical vibration.

The magnets 130 are disposed in parallel on both sides of the voice coil plate 150. The magnet 130 may be a rod-shaped magnet having different polarities vertically.

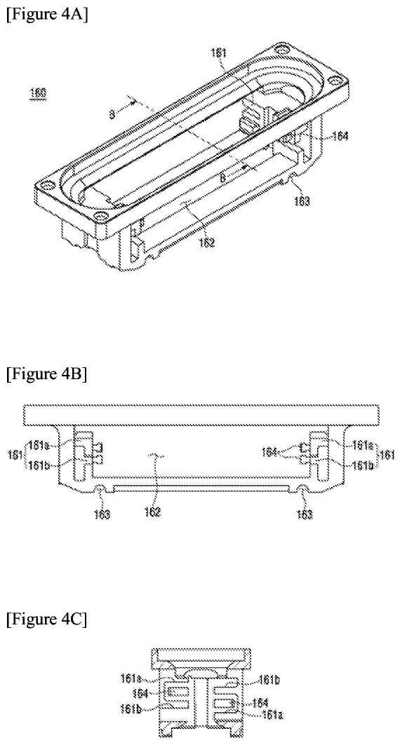

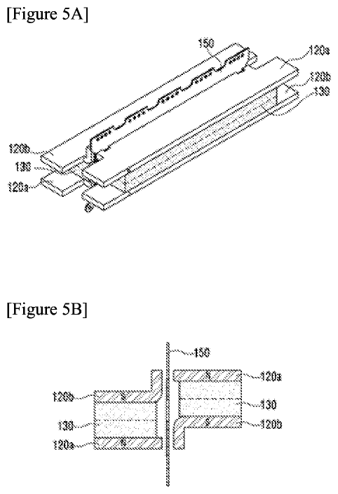

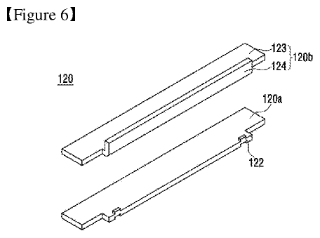

FIG. 4 is a perspective view (a), a side view (b), and a cross-sectional view (c) of the base frame 160 according to an embodiment of the present invention. FIG. 5(a) is a diagram illustrating the configuration and arrangement of a magnetic circuit according to an embodiment of the present invention. FIG. 5(b) is a side view of FIG. 5(a). FIG. 6 is a perspective view (lower) of a first yoke 120a and a perspective view (upper) of a second yoke 120b according to an embodiment of the present invention.

Referring to FIGS. 5 and 6, the yoke 120 includes a first yoke 120a having a “-” shape in cross section and a second yoke 120b having an “L” shape in cross section. The first yoke 120a and the second yoke 120b may be disposed to face each other with respect to the voice coil plate 150 and may be asymmetric.

The first yoke 120a is disposed on the N-pole or S-pole surface of the magnet 130. The second yoke 120b is disposed on the S-pole or N-pole surface of the magnet 130. The first yokes 120a and the second yokes 120b are disposed such that different polarities face each other.

Preferably, the first yoke is disposed on the N-pole surface of the magnet. The second yoke is disposed on the S-pole surface of the magnet. The magnetic field starting from the first yoke having a narrow area moves to the second yoke. Accordingly, magnetic field circulation may be efficiently improved.

To prevent the magnets 130 from contacting each other due to attraction, the first yoke 120a may include a magnet fixing part 122 protruding in the direction of the magnet 130 to limit movement of the magnet 130.

The magnet fixing part 122 may be formed through half-blanking processing.

Half blanking processing is a processing method for forming a shear fault having the same shape as a punch in the processing material by stopping the progress of the punch just before the blanking is completed.

The magnet fixing part 122 of the first yoke 120a may fix one side of the magnet 130, that is, one side of the magnet 130 disposed adjacent to the voice coil plate 150.

As described above, magnets 130 having different polarities are asymmetrically disposed around the voice coil plate 150. Therefore, an attraction may act between the magnets 130 facing each other.

Conventionally, in addition to the process of fixing the yoke 120 to the base frame 160, a bonding process of attaching the magnet 130 to the yoke 120 was required.

However, according to the present invention, the side surface of the magnet 130 is caught in the magnet fixing part 122 and movement of the magnet 130 toward the inside is restricted. Therefore, a bonding process of attaching the magnet 130 to the first yoke 120a may be omitted. Therefore, it is possible to reduce the production process and the use of subsidiary materials.

The second yoke 120b includes a base portion 123 in contact with the magnet 130 and a bent portion 124 which is bent in an orthogonal direction of the base portion 123. The bent portion 124 may be positioned adjacent to a side surface portion of the voice coil plate 150.

Referring to FIGS. 3(c) and 5(b), the bent portion 124 may be bent toward a direction opposite to that of the magnet 130.

That is, when the second yoke 120b is positioned on an upper surface of the magnet 130, the bent portion 124 may be bent upward, and when the second yoke 120b is positioned on a lower surface of the magnet 130, the bent portion 124 may be bent downward.

In addition, an upper surface or a lower surface of the first yoke 120a and a front end surface of the bent portion 124 of the second yoke 120b may be placed on the same horizontal extension line.

As shown in FIG. 3(c) and FIG. 5(b), magnets on both sides of the voice coil plate 150 may be disposed at different upper and lower positions as the upper surface or the lower surface of the first yoke 120a and the front end surface of the bent portion 124 of the second yoke 120b are placed on the same horizontal extension line.

As shown in FIGS. 4(a) and 4(b), the base frame 160 may include side through holes 162 penetrated through both sides to insert the magnet 130 and the yoke 120 into the inner space, a yoke guide part 161 which fixes both ends of the yoke 120 to limit a minimum distance g between the yokes 120 inserted into the inner space, and at least one insertion holes 163 formed on both sides.

A jig may be fixed to the base frame 160 through the insertion hole 163, and the center of the voice coil plate 150 may be guided using the fixed jig.

The yokes 120 disposed on both sides of the voice coil plate 150 may be spaced apart from the voice coil plate 150 by equal distances g1 and g2, and the distance between the yokes 120 may form an air gap g, which is a passage through which air moves when the voice coil plate 150 moves up and down.

Accordingly, by limiting the minimum value of the separation distances g1 and g2 between the voice coil plates 150 and the yokes 120 using the yoke guide part 161, the air gap g may be stably maintained, and the deterioration of the sound quality of the speaker may be prevented even in long-term use.

As illustrated in FIG. 4, the yoke guide part 161 may include a first yoke guide 161a to which both end portions of the first yoke 120a are fixed and a second yoke guide 161b to which both end portions of the second yoke 120b are fixed.

The yoke guide parts 161 on both sides of the voice coil plate 150 may be asymmetric.

That is, the first yoke guide 161a and the second yoke guide 161b may be disposed to face each other with respect to the voice coil plate 150.

In addition, the yoke guide part 161 may further include a magnet guide part 164 restricting movement of the magnet 130 in the longitudinal direction.

That is, the magnet 130 may be stably fixed to the base frame 160 by being restricted from moving in a width direction by the magnet fixing part 122 of the first yoke 120a and restricted from moving in a length direction by the magnet guide part 164.

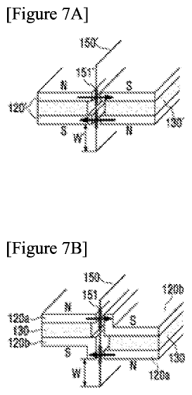

FIG. 7 is a reference diagram for explaining a difference between a conventional flat speaker (a) and a flat speaker (b) according to an embodiment of the present invention.

The yokes 120 are disposed on the upper and lower surfaces of the magnet 130 to have the same polarity as the magnet 130 in contact.

Accordingly, the flat speaker b according to an embodiment of the present invention may expect the same performance as using the magnet 130 having the corresponding pole expanded in size (thickness) by changing and applying the cross section of the yoke 120.

That is, the flat speaker 100 according to the present invention has the same performance as using a magnet 130 having an S-pole or N-pole with a thickness which has a value of being added by the height of the bent portion 124 of the second yoke 120b, but the size of the magnet 130 actually applied is small, thereby reducing cost.

In addition, yoke 120 having different polarities are disposed opposite to both sides of the voice coil plate of the flat speaker, that is, at a position corresponding to the voice coil.

As shown in FIG. 7(a), in the case of a conventional flat plate-type speaker, the yoke 120′ having different polarities and the same cross-section (thickness) is disposed to face a position corresponding to the voice coil 151′.

Therefore, when the amplitude W′ is large, that is, when a low-band signal is input, the amplitude W′ of the voice coil plate 150′ is significantly greater than the thickness of the yoke 120′, and as a result, a reverse magnetic field is applied to the end of the voice coil plate 151′, and vertical vibration of the voice coil plate 150′ is not normally progressed.

However, according to the present invention, as shown in FIG. 7(b), the second yoke 120b has a thickness enlarged by the bent portion 124, and thus, even when the amplitude is large, that is, the amplitude of the voice coil plate 150 does not exceed the thickness of the second yoke 120b, thereby a problem of applying a reverse magnetic field to the end of the voice coil 151 is prevented.

Accordingly, the vertical vibration of the voice coil plate 150 is stably performed, and as a result, low sound as well as high output sound may be smoothly reproduced.

In addition, the magnetic field flows from the N pole to the S pole. The magnetic field starting from the N pole has the property of adhering to the nearest S pole at distance. Therefore, the magnetic field (the present invention) starting from the first yoke 120a (N pole) having a smaller area than the second yoke 120b (S pole) is more strongly formed than the magnetic field (prior art) flowing from the N pole having the same area to the S pole. And, this magnetic field can spread wider.

The spread magnetic field adheres to the nearest S pole, that is, the second yoke 120b disposed on the opposite side with respect to the voice coil plate 150, and the second yoke 120b receives a wide magnetic field transferred from the first yoke 120a using a large area of the bent portion 124 to facilitate circulation of the magnetic field.

That is, when the magnetic field is smoothly circulated using the bent portion 124 of the second yoke 120b, the vertical movement of the voice coil plate 150 becomes smooth, and as a result, it is possible to help improve the sound quality of the speaker.

In addition, the side through hole 162 of the base frame 160 and the rear (space) of the bent portion 124 of the second yoke 120b may facilitate the air flow inside the speaker, thereby facilitating the vertical movement of the voice coil plate 150 and consequently improving the sound quality of the speaker.

That is, according to the present invention, it is possible to implement a flat speaker 100 capable of reducing production processes and reducing costs as well as improving performance such as smooth sound reproduction and sound quality maintenance compared to existing flat speakers.

Features, structures, effects, and the like described in the embodiments are included in an embodiment of the present invention, and are not necessarily limited to one embodiment. Furthermore, the features, structures, effects, and the like illustrated in each embodiment may be implemented in combination or modification with other embodiments by a person of ordinary skill in the field to which the embodiments belong. Therefore, it should be interpreted that the contents related to these combinations and modifications are included in the scope of the present invention.

In addition, although the embodiment has been mainly described above, this is merely an example and the present invention is not limited, and it will be appreciated by a person skilled in the art that various modifications and applications not illustrated are possible within the essential characteristics of this embodiment.

For example, each component specifically shown in the embodiment may be modified and implemented. And differences related to these modifications and applications should be interpreted as falling within the scope of the present invention as defined in the appended claims.

### REFERENCE NUMERALS

100: flat panel speaker
220: fixing member
110: damper
120: yoke
130: magnet
140: diaphragm.
150: voice coil plate
160: base frame
210: lead terminal
220: gasket (fixing member)
120a: first yoke
120b: second yoke
122: magnet fixing part
123: base portion
124: bent portion
151: voice coil
161: yoke guide
162: side through hole
163: insertion hole
164: magnet guide part
161a: first yoke guide
161b: second yoke Guide
g: air gap
g1, g2: distance between the voice coil plate and the yoke.
W: amplitude

1. A flat speaker, comprising:
a voice coil plate;
a diaphragm which generates sound according to vertical vibration of the voice coil plate;
a damper in contact with a lower end surface of the voice coil plate;
magnets disposed in parallel on both sides of the voice coil plate; and
a yoke,
wherein
the yoke has a first yoke having a “-” shape in cross section and a second yoke having an “L” shape in cross section and the first and second yokes are disposed to face to each other to form asymmetry.

2. The flat speaker of claim 1, wherein
the second yoke further comprises:
a base portion in contact with the magnet; and
a bent portion which is bent in an orthogonal direction of the base portion, and
the bent portion is positioned adjacent to a side surface portion of the voice coil plate.

3. The flat speaker of claim 1, wherein
the first yoke further comprises:
a magnet fixing part protruding to prevent the magnets from contacting each other due to attraction.

4. The flat speaker of claim 1, further comprising:
a base frame supporting the diaphragm and the damper,
wherein
the base frame further comprises:
side through holes penetrated through both sides so that the magnet and the yoke can be inserted into an inner space; and
a yoke guide part fixing both ends of the yoke to limit a minimum value of the spacing distance between the magnets inserted into the inner space.

5. The flat speaker of claim 4, wherein
the base frame further comprises:
at least one insertion holes formed in each of both side surfaces,
wherein
a jig is fixed through the insertion hole to guide a center of the voice coil plate by the jig.

6. The flat speaker of claim 1, wherein
the second yoke further comprises:
a base portion in contact with the magnet; and
a bent portion which is bent in an orthogonal direction of the base portion,
wherein
when the second yoke is positioned on an upper surface of the magnet, the bent portion is bent upward,
when the second yoke is positioned on a lower surface of the magnet, the bent portion is bent downward.

7. The flat speaker of claim 1, wherein
the second yoke further comprises:
a base portion in contact with the magnet; and
a bent portion which is bent in an orthogonal direction of the base portion,
wherein
an upper surface or a lower surface of the first yoke and a front end surface of the bent portion are placed on a same horizontal extension line.

8. The flat speaker of claim 1, wherein
the first yoke is disposed on an N-pole surface of the magnet, and
the second yoke is disposed on a S pole surface of the magnet.

9. The flat speaker of claim 1, wherein
the magnets are disposed at different vertical positions with respect to the voice coil plate.
